(19) United States
(12) Patent Application Publication
(10) Pub. No.: US 2010/0211958 A1
(43) Pub. Date: Aug. 19, 2010

(54) AUTOMATED RESOURCE LOAD BALANCING IN A COMPUTING SYSTEM

(75) Inventors: Carl T. Madison, JR., Windsor, CO (US); John R. Kostraba, JR., Broomfield, CO (US)

Correspondence Address: BROOKS KUSHMAN P.C. /Oracle America/ SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 12/372,089

(22) Filed: Feb. 17, 2009

(51) Int. Cl. G06F 9/46; G06F 12/02; G06F 1/26; G06F 11/30

(52) U.S. Cl. 718/105; 713/340; 713/300; 711/170; 718/1

(57) ABSTRACT

A method for automated resource load balancing in a computing system includes partitioning a plurality of physical resources to create a plurality of dedicated resource sets. A plurality of separate environments are created on the computing system. Each created separate environment is associated with at least one dedicated resource set. The method further includes establishing a user policy that includes a utilization threshold, and for each separate environment, monitoring the utilization of the associated at least one dedicated resource set. The physical resources associated with a particular separate environment are automatically changed based on the monitored utilization for the particular separate environment, and in accordance with the user policy. This provides automated resource load balancing in the computing system.

### BACKGROUND OF THE INVENTION

1. Field of the Invention

The invention relates to automated resource load balancing in a computing system.

2. Background Art

Software applications have changing resource demands. The factors that influence changes in resource demands are highly variable depending on the computing environment. Some of these factors are: changing number of system users, upgrading or updating application software, upgrading or updating operating systems, and database table/index modification and/or data bloat.

The implementation of load balancing in information systems is widespread. For example, a medium traffic website may be implemented on a single physical server. To increase capacity beyond the capabilities of the single physical server, a plurality of identical physical servers may be used together with an expensive switch that distributes sessions among the plurality of physical servers.

In more detail, a computing system has a plurality of physical resources that are used to provide services. These physical resources may include, for example, processors, memory, and other hardware resources. The computing system uses the available physical resources to handle a plurality of workloads. In general, a workload is a set of related processes. Resource management is the controlling of resources and the allocation of resources among workloads on the computing system.

Virtualization relates to creating an abstraction layer between software applications and physical resources. There are many approaches to virtualization. With server virtualization, applications can be consolidated onto a fewer number of servers. For example, multiple virtual servers may exist on a single physical server.

In one existing approach to virtualization, virtual machines are used. In this approach to virtualization, software running on the host operating system (or in some cases below the host operating system) allows one or more guest operating systems to run on top of the same physical hardware at the same time. In this approach, the guest operating system is a full operating system, including the kernel and libraries.

Multiple virtual machines running on a computing system provide a way for software applications to share the physical resources of the computing system, while at the same time, isolating the applications from each other. The computing system may be configured so that hardware resources are divided among the virtual machines. Such configuration may involve static assignment of dedicated resources to the virtual machines.

The static assignment of dedicated resources to virtual constructs, such as virtual machines, has advantages. Proper performing of the resource allocation process requires specialized labor.

However, due to the fact that software applications have changing resource demands, with many factors influencing the changes, the static assignment of resources still results in some inefficient use of resources, including power, in a typical computing environment, particularly as resource demands dynamically change while the assigned resources are fixed.

For the foregoing reasons, there is a need for an improved approach to resource load balancing in a computing system.

### SUMMARY OF THE INVENTION

In one aspect of the invention, a computing system is provided that has the capability to automatically change the allocation of resources including, for example, dedicated processors, network bandwidth, etc., in a virtual machine based on resource utilization and user setable policies. The virtual machine is generally an operating system and application service combination that is created and managed independent of physical processor/server hardware.

Embodiments of the invention may provide many advantages by automating resource allocation processes that are currently performed with specialized labor or not performed at all. Accordingly, embodiments of the invention may save valuable resources in information systems, including power, in typical computing environments.

It is appreciated that embodiments of the invention may be utilized with virtual machines or other virtual constructs such as virtual operating systems. As well, embodiments of the invention are not limited to virtual environments and may be used with any other entity where appropriate resource control frameworks exist.

### BRIEF DESCRIPTION OF THE DRAWINGS

FIG. 1 illustrates a computing system including physical resources partitioned into resource sets, separate environments, and a monitor and allocation service to provide automated resource load balancing;

FIG. 2 illustrates a method for automated resource load balancing in the computing system;

FIG. 3 illustrates the computing system, wherein the allocation of physical resources has changed from the allocation depicted in FIG. 1;

FIG. 4 illustrates a plurality of resource sets, wherein the physical resources include processors, memory, and network bandwidth;

FIG. 5 illustrates the plurality of resource sets, wherein the allocation of memory and network bandwidth has changed from the allocation depicted in FIG. 4;

FIG. 6 illustrates the computing system using virtual machines to implement the separate environments;

FIG. 7 illustrates the computing system using virtual operating systems to implement the separate environments;

FIG. 8 illustrates a method including the powering up of additional physical resources for use in the dedicated resource sets;

FIG. 9 illustrates a method including the powering down of a portion of the physical resources to reduce physical resources available for use in the dedicated resource sets;

FIG. 10 illustrates a distributed computing environment wherein the separate environments such as virtual machines, virtual operating systems, or other virtual constructs or entities with an appropriate resource control framework are dynamically distributed over physical resources; and

FIG. 11 illustrates an additional example of automated resource load balancing, and shows the re-allocation of physical resources from an initial allocation to a new allocation.

### DETAILED DESCRIPTION OF THE PREFERRED EMBODIMENTS

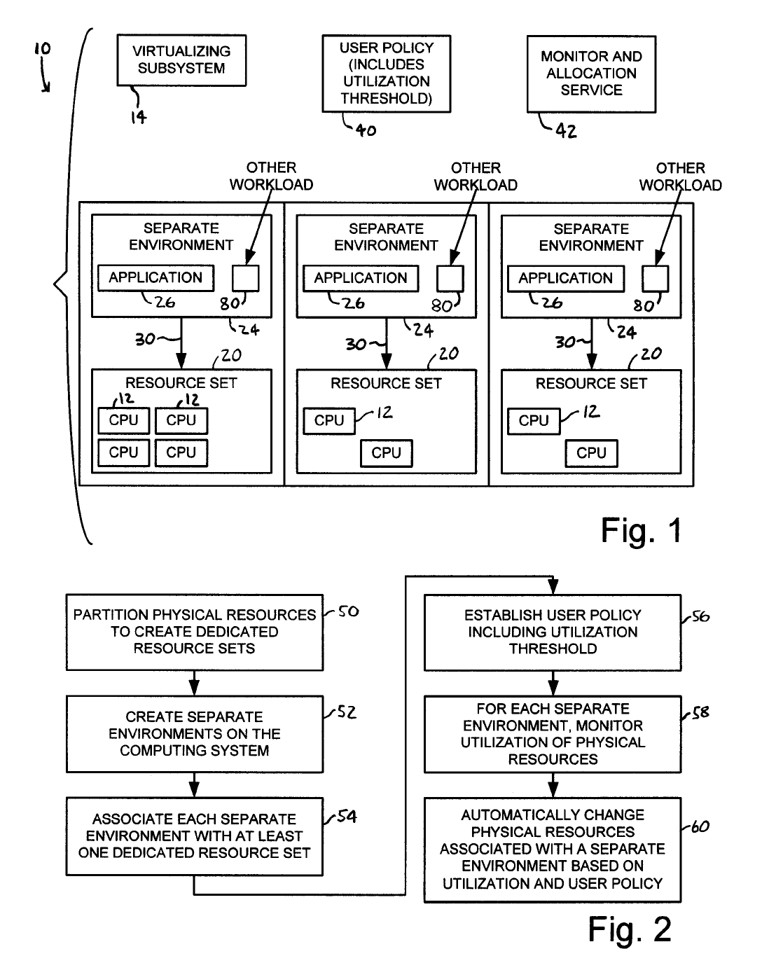

In FIG. 1, a computing system is generally indicated at 10. Computing system 10 includes a plurality of physical resources 12. As shown, the physical resources include a plurality of processors. The physical resources may include other physical resources such as, for example, memory, network bandwidth, etc. The plurality of physical resources 12 is partitioned to create a plurality of dedicated resource sets 20. Further, a plurality of separate environments 24 is created on the computing system 10. Typically, the partitioning to create resource sets 20 and the creation of separate environments 24 is performed by a virtualizing subsystem 14. Further, the virtualizing subsystem 14 associates (arrows 30) each created separate environment 24 with at least one dedicated resource set 20. The separate environments 24 isolate applications 26 from each other. It is appreciated that the separate environments 24 may be implemented as virtual machines, virtual operating systems, other virtual constructs, or other entities where appropriate resource control frameworks exist to isolate applications 26 or other workloads 80 from each other.

With continuing reference to FIG. 1, a user policy 40 includes a utilization threshold. Monitor and allocation service 42, for the separate environments 24, monitors the utilization of associated dedicated resource sets 20. Depending on the monitored utilization for a particular separate environment 24, physical resources associated with the particular separate environment 24 are changed to provide automated resource load balancing in the computing system 10.

In general, computing system 10, shown in FIG. 1, has the capability to automatically change the allocation of physical resources 12 which could be dedicated processors or other physical resources, among separate environments 24. In this way, separated environments such as virtual machines are distributed over physical resources or physical servers, dynamically, with the allocation or assignment of resources being changed automatically in response to changing resource demands by the applications 26 or other workloads 80.

A preferred method for the automated resource load balancing is depicted in FIG. 2. At block 50, physical resources are partitioned to create resource sets. The physical resources may take a variety of forms, and may also be distributed among one or more physical servers or computers. That is, computing system 10 may take the form of a single computer or a group of computers. At block 52, the separate environments are created on the computing system. At block 54, each separate environment is associated with at least one dedicated resource set. Put another way, the separate environments are dynamically distributed over the physical resources. Distributing workloads over physical resources in this way may be referred to as distributed computing or cloud computing. The static assignment of dedicated resources to virtual constructs, such as virtual machines, is known. However, proper performing of the resource allocation process requires specialized labor. In accordance with the embodiment of the invention illustrated in FIGS. 1 and 2, at block 56, a user policy including a utilization threshold is established. At block 58, for each separate environment, utilization of physical resources is monitored. At block 60, physical resources associated with the separate environment are automatically changed based on the utilization and user policy. Advantageously, the automated changing and reallocation of physical resources allows the resource allocation to accommodate the changing resource demands that occur with software applications based on various influencing factors.

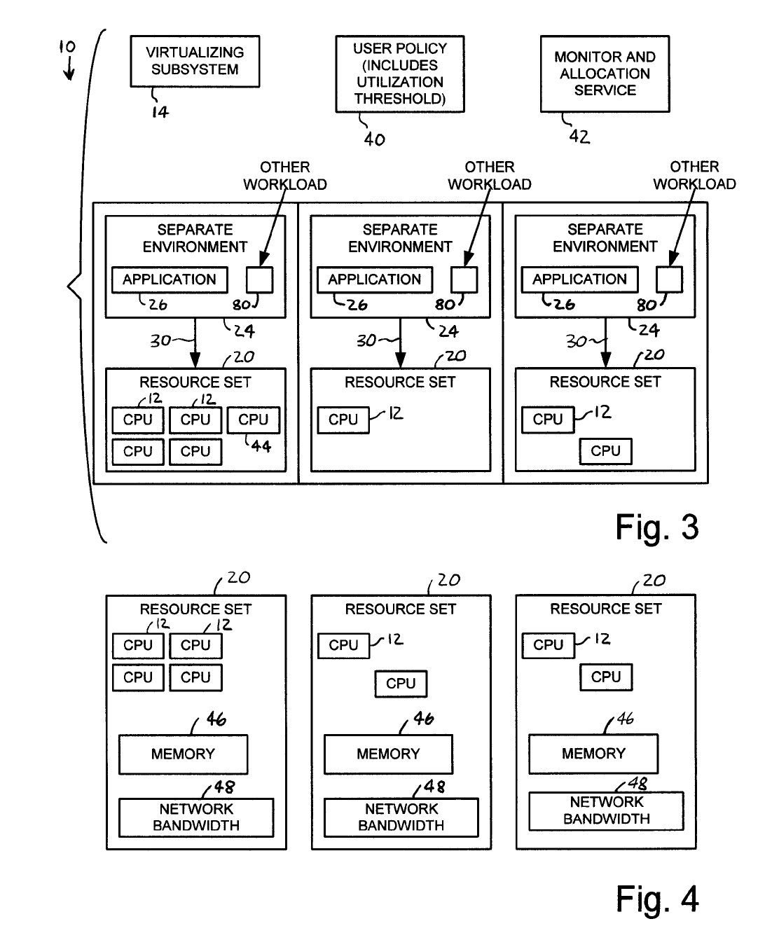

Referring now to FIG. 3, the computing system 10 is again depicted, similar to FIG. 1. However, in FIG. 3, the physical resources of the computing system 10 have been reallocated in response to changing resource demands. Specifically, note that the distribution of processors among the resource sets 20 in FIG. 1 is 4-2-2. In FIG. 3, the distribution of processors is 5-1-2, with additional processor 44 moved from the middle resource set 20 to the resource set 20 on the left-hand side of FIG. 3.

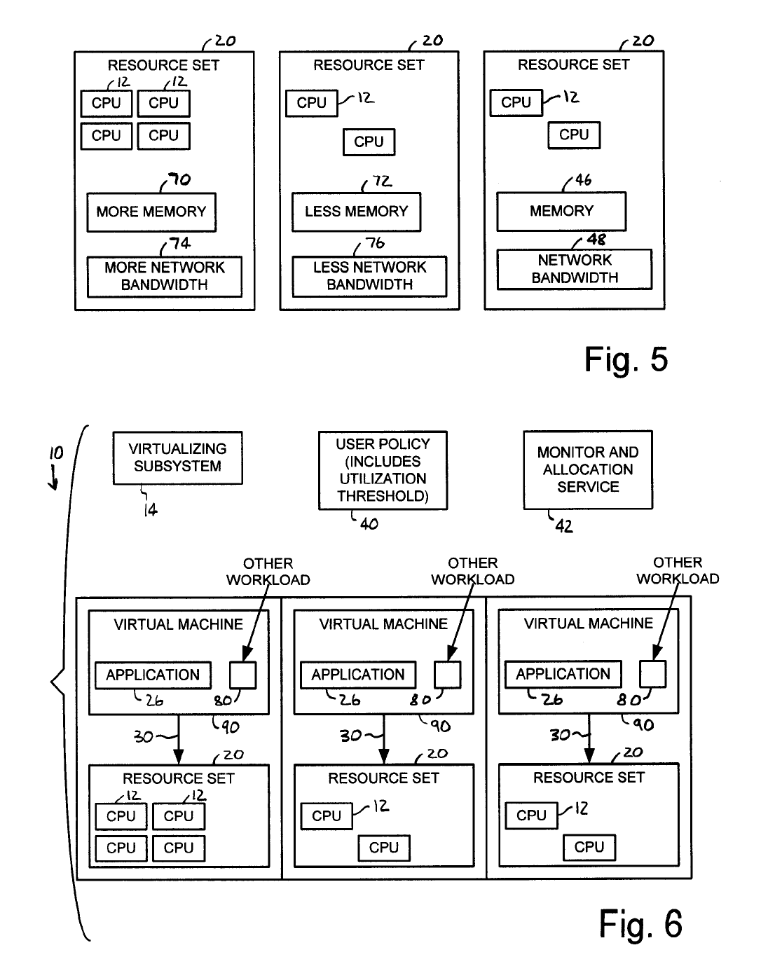

Turning now to FIG. 4, the resource sets 20 are shown further including memory 46 and network bandwidth 48 as physical resources. FIG. 5 illustrates reallocation of resources and network bandwidth in the resource sets 20. Note the indication of more memory 70 in the left side resource set 20 and the indication of less memory 72 in the center resource set 20. Similarly, note the indication of more network bandwidth 74 in the left side resource set 20, and the indication of less network bandwidth 76 in the center resource set 20.

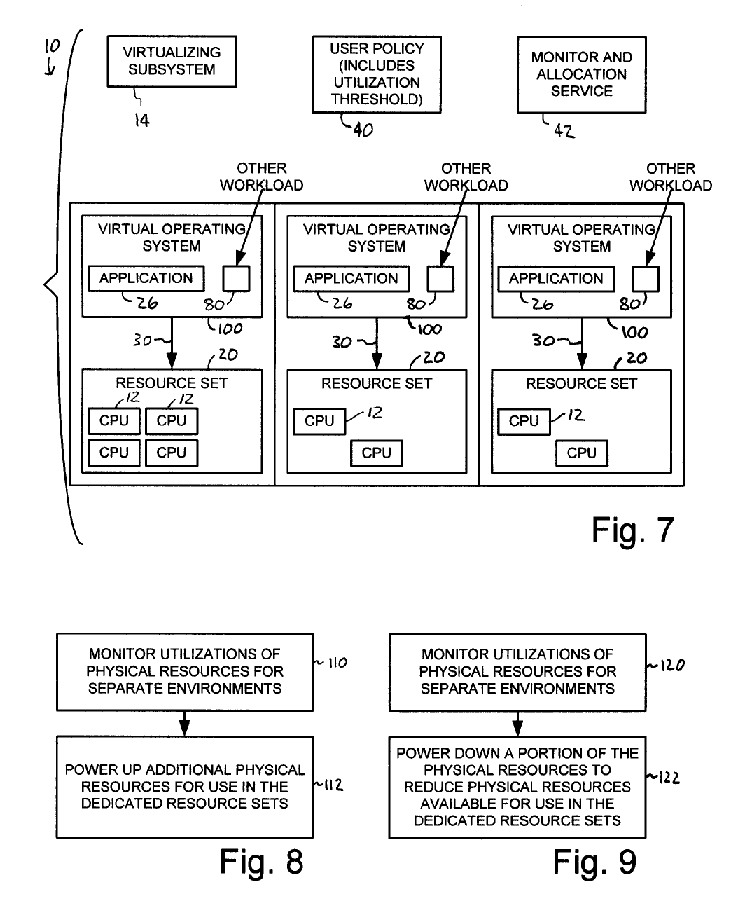

FIG. 6 illustrates the computing system 10 wherein virtual machines 90 are used to implement the separate environments 24. FIG. 7 illustrates the computing system 10 using virtual operating systems 100 to implement the separate environments 24. As apparent from FIGS. 6 and 7, embodiments of the invention are not limited to any particular separate environments, and it is appreciated that these separate environments may take a variety of forms.

FIGS. 8 and 9 illustrate another aspect of embodiments of the invention. In addition to the fact that software applications have changing resource demands, and the fact that monitoring and reallocation of physical resources in accordance with embodiments of the invention allow the resource sets to dynamically change in response to the changing resource demands, embodiments of the invention also contemplate powering up and powering down of physical resources for the resource sets.

In general, data center power consumption is very large, typically megawatts of power per floor of a data center site. Power consumption by data centers continues to grow as demands for computing systems increase and the cost and availability of power has become a major concern. In accordance with this aspect of the invention, a computing system may automatically manage the power state of its resources. For example, the computing system 10 may be composed of a plurality of physical servers, with each server including physical resources. During operation, utilization is monitored and the physical resources are reallocated as needed to the various applications or other workloads distributed on the computing system. In certain circumstances, there may be additional physical servers available that are currently powered off to save energy. When needed, one or more additional servers may be powered up for use in the dedicated resource sets. Similarly, if the resource demands decline over time, a portion of physical resources may be powered down to conserve power, with the applications and workloads being reallocated to the remaining, powered on computers. In the example, computers are powered on and off as needed, but it is to be appreciated that this concept applies to the powering up and powering down of any physical resources that may be used in the dedicated resource sets. In addition, another aspect of this concept involves the anticipation of the need for more resources or a need for less resources. In this way, if it is anticipated based on monitoring that additional resources will be needed, additional resources may be powered up ahead of time such that these resources are available when needed.

FIGS. 8 and 9 give examples of these aspects of the invention. In FIG. 8, at block 110, utilizations of physical resources for the separate environments are monitored. At block 112, additional physical resources are powered up for use in the dedicated resource sets. In FIG. 9, at block 120, utilizations of physical resources for separate environments are monitored. At block 122, a portion of the physical resources are powered down to reduce physical resources available for use in the dedicated resource sets.

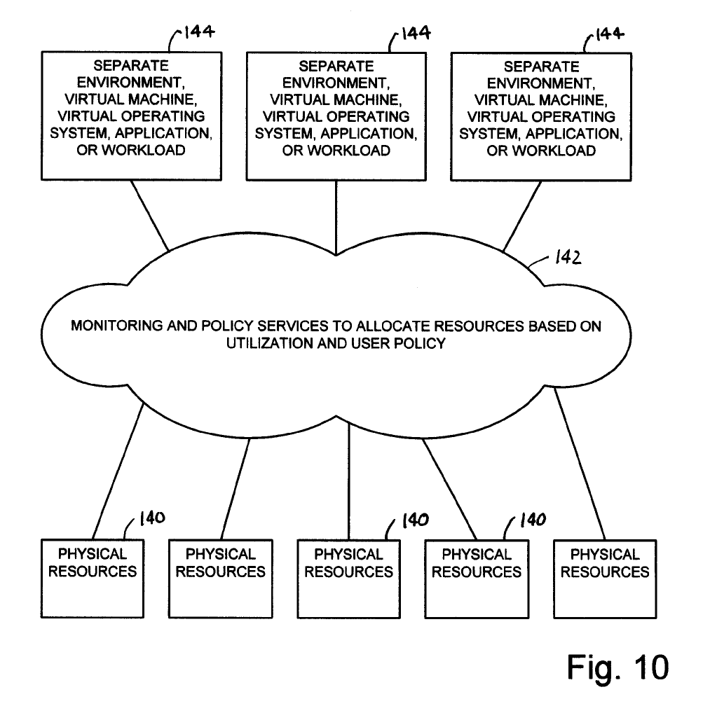

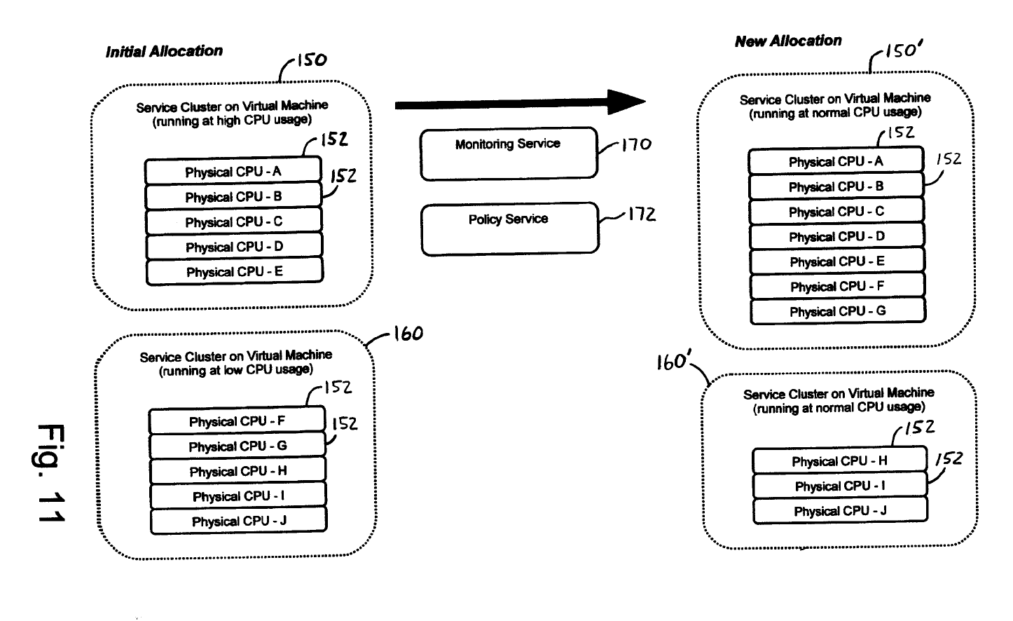

FIG. 10 illustrates a distributed computing environment in accordance with an embodiment of the invention. The physical resources are indicated at 140 and may take a variety of forms. For example, physical resources 140 may be distributed among a plurality of available computers. Cloud 142 depicts the availability of physical resources 140 for applications and other workloads. In more detail, cloud 142 indicates the monitoring and policy services allocating physical resources based on utilization of the physical resources and user policy. Each block 144 indicates a separate environment, virtual machine, virtual operating system, application, or workload. In operation of the computing system, each environment 144 is associated with a limited set of physical resources 140. Utilization of the resources is monitored, and as needed, the allocation of physical resources among the environments 144 is changed to provide automated resource load balancing in the computing system in response to changes in resource demands by the applications or workloads. That is, the separate environments are dynamically distributed over the physical resources.

An additional example of automated resource load balancing in an embodiment of the invention is depicted in FIG. 11. In this example, block 150 indicates a service cluster on a virtual machine, and block 160 also indicates a service cluster on a virtual machine. Each service cluster 150, 160, in the initial allocation depicted on the left side of FIG. 11, is associated with a group of physical processors 152. The monitoring service is indicated at 170, and the policy service is indicated at 172. These services run on the computing system, in this case service clusters 150 and 160, and perform the monitoring of the utilization for each service cluster. In more detail, the monitoring service 170 detects that the processor utilization is over the policy threshold dictated by policy service 172. In turn, monitoring service 170 chooses a new allocation and initiates the processor allocation change. On the right side of FIG. 11, the new allocation is shown. Service cluster 150 becomes service cluster 150′ and service cluster 160 becomes service cluster 160′. The physical processors 152 have been reallocated such that service cluster 150′ now contains additional physical processors taken from the other service cluster. As noted above, the policy may monitor processor usage or other physical resources such as, for example, internal/local storage media, memory, network interfaces, etc.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for automated resource load balancing in a computing system, the computing system including a plurality of physical resources and a virtualizing subsystem, the virtualizing subsystem being capable of partitioning the plurality of physical resources to create dedicated resource sets, the virtualizing subsystem being further capable of creating separate environments on the computing system that logically isolate applications from each other, and associating created separate environments with created dedicated resource sets, the method comprising:
partitioning the plurality of physical resources to create a plurality of dedicated resource sets;
creating a plurality of separate environments on the computing system;
associating each created separate environment with at least one dedicated resource set;
establishing a user policy that includes a utilization threshold;
for each separate environment, monitoring the utilization of the associated at least one dedicated resource set; and
automatically changing the physical resources associated with a particular separate environment based on the monitored utilization for the particular separate environment, and in accordance with the user policy, thereby providing automated resource load balancing in the computing system.

2. The method of claim 1 further comprising:
running a service on the computing system, the service performing the monitoring of the utilization for each separate environment, and the service performing the automatic changing of the physical resources.

3. The method of claim 1 wherein the physical resources include a plurality of processors.

4. The method of claim 1 wherein the physical resources include memory.

5. The method of claim 1 wherein the physical resources include network bandwidth available to the computing system.

6. The method of claim 1 wherein creating the plurality of separate environments further comprises:
creating a separate environment as a virtual machine.

7. The method of claim 1 wherein creating the plurality of separate environments further comprises:
creating a separate environment as a virtual operating system.

8. The method of claim 1 wherein creating the plurality of separate environments further comprises:
creating the plurality of separate environments, each separate environment including a workload.

9. The method of claim 1 further comprising:
based on the monitored utilizations for the separate environments and in accordance with the user policy, powering up additional physical resources for use in the plurality of dedicated resource sets.

10. The method of claim 1 further comprising:
based on the monitored utilizations for the separate environments and in accordance with the user policy, powering down a portion of the physical resources to reduce an amount of physical resources available for use in the plurality of dedicated resource sets.

11. A computer-readable storage medium having instructions stored thereon that are executable by a computing system to perform a method for automated resource load balancing in the computing system, the computing system including a plurality of physical resources and a virtualizing subsystem, the virtualizing subsystem being capable of partitioning the plurality of physical resources to create dedicated resource sets, the virtualizing subsystem being further capable of creating separate environments on the computing system that logically isolate applications from each other, and associating created separate environments with created dedicated resource sets, the method comprising:
partitioning the plurality of physical resources to create a plurality of dedicated resource sets;
creating a plurality of separate environments on the computing system;
associating each created separate environment with at least one dedicated resource set;
establishing a user policy that includes a utilization threshold;
for each separate environment, monitoring the utilization of the associated at least one dedicated resource set; and
automatically changing the physical resources associated with a particular separate environment based on the monitored utilization for the particular separate environment, and in accordance with the user policy, thereby providing automated resource load balancing in the computing system.

12. The medium of claim 11, the method further comprising:
running a service on the computing system, the service performing the monitoring of the utilization for each separate environment, and the service performing the automatic changing of the physical resources.

13. The medium of claim 11 wherein the physical resources include a plurality of processors.

14. The medium of claim 11 wherein the physical resources include memory.

15. The medium of claim 11 wherein the physical resources include network bandwidth available to the computing system.

16. The medium of claim 11 wherein creating the plurality of separate environments further comprises:
creating a separate environment as a virtual machine.

17. The medium of claim 11 wherein creating the plurality of separate environments further comprises:
creating a separate environment as a virtual operating system.

18. The medium of claim 11 wherein creating the plurality of separate environments further comprises:
creating the plurality of separate environments, each separate environment including a workload.

19. The medium of claim 11, the method further comprising:
based on the monitored utilizations for the separate environments and in accordance with the user policy, powering up additional physical resources for use in the plurality of dedicated resource sets.

20. The medium of claim 11, the method further comprising:
based on the monitored utilizations for the separate environments and in accordance with the user policy, powering down a portion of the physical resources to reduce an amount of physical resources available for use in the plurality of dedicated resource sets.
